(19) United States
(12) Patent Application Publication
(10) Pub. No.: US 2007/0053185 A1
(43) Pub. Date: Mar. 8, 2007

(54) Light source module

(76) Inventors: Tony Whitehead, Hsinchu City (TW); Da-Shuang Kuan, Cyonglin Township (TW); Chia-Te Lin, Lioujiao Township (TW)

Correspondence Address: J C PATENTS, INC., 4 VENTURE, SUITE 250, IRVINE, CA, 92618, US

(21) Appl. No.: 11/223,499

(22) Filed: Sep. 8, 2005

(51) Int. Cl. F21S 13/14

(52) U.S. Cl. 362/252

(57) ABSTRACT

A light source module is provided. The light source module comprises a substrate, a reflective device and a plurality of light emitting diodes. The substrate comprises an opening, the reflective device a comprising light reflecting surface is disposed on one side of the substrate. In addition, the light emitting diode is disposed over the substrate locating between the reflective device and the substrate, and the LEDs are arranged in a plurality of concentric circles around the opening of the substrate. Lights emitted by the light emitting diodes are reflected the light reflecting surface pass through the opening converge on the other side of the substrate. The light source module is constructed using simple optical components and is capable of outputting uniform light.

### BACKGROUND OF THE INVENTION

1. Field of the Invention

The present invention relates to a light source module, and more particularly, to a light source module in which a plurality of LEDs arranged concentrically for providing uniform light output.

2. Description of Related Art

As computer technology rapidly advances and as Internet and multimedia technologies are being highly developed, current image information is transmitted in digital format instead of analog format. In order to comply with modern life style, video or image apparatus are being designed to be lighter and thinner. A conventional CRT is advantageous in some ways, yet the internal electronic cavity structure occupies substantial space and radiation thereby are hazardous to human eyes. Therefore, a flat display fabricated with optoelectronic technology and semiconductor process, such as liquid crystal display (LCD), organic light emitting display (OLED), or plasma display panel (PDP), is becoming the main trend.

As to LCD, it includes LCD monitor and digital LCD television belonging to flat display, and LCD projector and back projection television belonging to micro-display. In recent years, LCD is featured with full color, large dimension, high resolution and low cost, where flat display is still a trade off between dimension and cost. Therefore, liquid crystal on silicon (LCOS) panel or high temperature polysilicon LCD (HTPS-LCD) that provide high resolution are being developed, along with optic engine for implementing LCD projector and back projection television are highlighted.

Since high-resolution liquid crystal panel in small dimension is applied to LCD projectors or LCD TVs, not only optical device of the optical engine needs to be located precisely, the uniformity and brightness of a light source thereof are also essential. Referring to FIG. 1, a schematic light source module of a non-flat display is illustrated. In conventional technology, a light emitting diode array serves as the light source, where a plurality of LEDs 102 are arranged in an array disposed over a substrate 120, and a optical lens module 120 is disposed over the LEDs 102 for converging lights emitted from the LEDs 102 and for focusing at a desired position.

However, the conventional technology possesses the following drawbacks:

1. A complicated optical lens module has to be provided and thereby rendering the apparatus bulky and heavy.

2. The optical lens module comprises complicated optical devices, such as lens, reflective mirror, thus high precision of correction and allocation are required, and thereby causing inconvenience in calibration and installation.

3. The light emitted from the LEDs need to be processed with a plurality of optical devices, which consumes more power, i.e. light efficiency is low.

4. The LEDs are arranged in an array, bringing light uniformity issue.

### SUMMARY OF THE INVENTION

In the light of the above description, the present invention is directed to a light source module comprising a plurality of concentrically arranged LEDs for outputting uniform light.

The present invention is also directed to a light source module in which a light emitting axis of a LED is adjusted using a reflecting surface of a reflective device in a manner to change the converging position of the light. Thus, this arrangement would allow a simpler design and lower the volume and weight of the light source module.

According to an embodiment of the present invention, the light source module comprises a substrate, a reflective device and a plurality of light emitting diodes. The substrate comprises an opening, the reflective device is disposed at one side of the substrate, and the reflective device comprises a light reflecting surface. Moreover, the LEDs are disposed over the substrate between the reflective device and the substrate, wherein each of the light emitting diodes are arranged around the opening in a plurality of concentric circles, wherein each of the LEDs emits a light to the light reflecting surface, and the lights pass through the opening and are converged at the other side of the substrate after being reflected by the light reflecting surface.

According to an embodiment of the present invention, the opening of the substrate is a circular hole, and the circular hole and the concentric circles share a common center. Moreover, each of the LEDs comprises a light emitting axis, for example, forming a same angle with the substrate, and the lights are emitted along the light emitting axis. Furthermore, the light reflective surface comprises a flat surface and a curved surface.

According to another embodiment of the present invention, the light source module comprises a substrate and a plurality of LEDs. The substrate comprises an opening, the LEDs are disposed over a surface of the substrate, and the LEDs are arranged around the openings in a plurality of concentric circles, wherein each of the LEDs is arranged to emit a light along a light emitting axis, and extension of the axes converge at a same position.

According to an embodiment of the present invention, the foregoing two light source modules further include a plurality of micro lenses, wherein each of the micro lenses is correspondingly disposed over one of the LEDs. Moreover, spaces between neighboring LEDs arranged along each of the concentric circles are substantially identical, and a light emitting axis of the LEDs arranged on a same concentric circle form identical angles with the substrate.

According to an embodiment of the present invention, the LEDs are arranged in concentric circles for providing a more uniform light compared to that of conventional art. Moreover, light emitting axis can be adjusted for changing focal point of the LEDs instead of using complicated optical mirror modules. Further, a number of concentrically arranged LEDs and the number of concentric circles of LEDs can be varied to vary brightness of the light. Therefore, volume, weight and fabrication cost are reduced, and device installation and calibration are simplified for the light source module according to this present invention.

### BRIEF DESCRIPTION OF THE DRAWINGS

FIG. 1 illustrates a schematic diagram of a conventional light source module of a non-flat display.

FIG. 2A illustrates a schematic side view of a light source module according to one embodiment of the present invention.

FIG. 2B illustrates a schematic diagram showing an arrangement of LEDs in the light source module shown in FIG. 2A.

FIG. 3A illustrates a schematic side view of a light source module according to another embodiment of the present invention.

FIG. 3B illustrates a schematic diagram showing an arrangement of LEDs in the light source module shown in FIG. 3A.

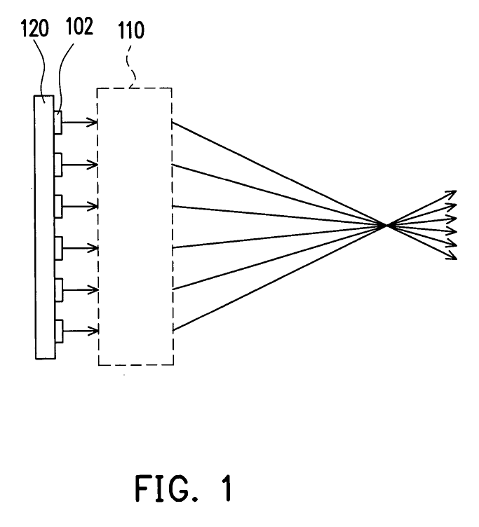

### DESCRIPTION OF THE PREFERRED EMBODIMENTS

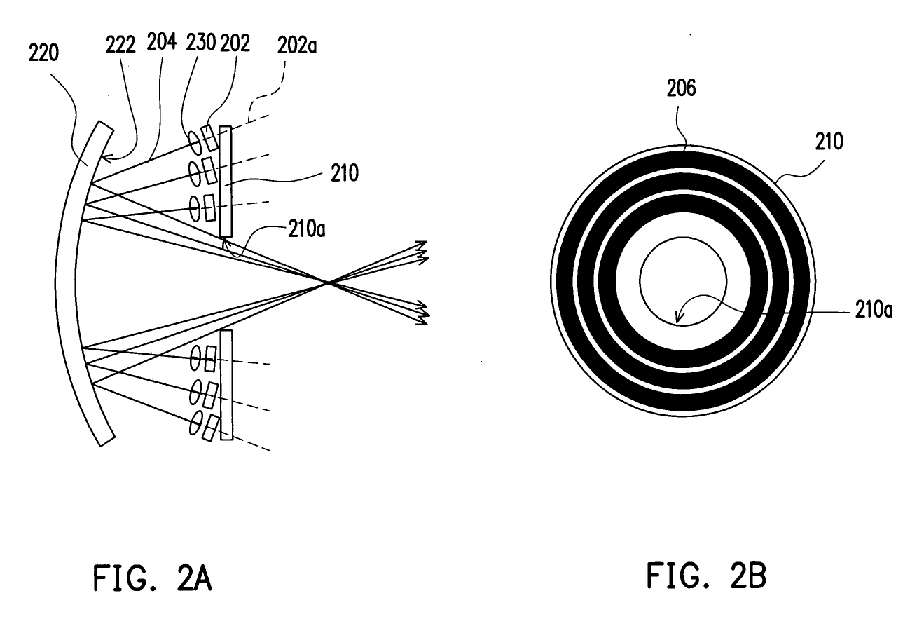

Referring to FIGS. 2A and 2B, FIG. 2A illustrates side view of a light source module according to one embodiment of the present invention, and FIG. 2B illustrates a schematic diagram showing an arrangement of LEDs in the light source module shown in FIG. 2A. A plurality of LEDs 202 is disposed over a surface of the substrate 210, wherein the substrate 210 comprises an opening 210a, which is, for example, a circular hole. The LEDs 202 are arranged around the opening 210a in concentric circles 206, and the concentric circles 206 and the opening 210a share a common center. Moreover, according to an embodiment of the present invention, a space between any two neighboring LEDs along one of the concentric circles 206 is maintained substantially identical so that the light emitted can be substantially uniform. Furthermore, a reflective device 220 having a reflecting surface 222 is disposed opposite to the LEDs 202. According to an embodiment of the present invention, the reflecting surface 222 is a curved surface.

According to an embodiment of the present invention, each of the above described LEDs comprises a light emitting axis 202a, wherein the light emitting axis of each of the LEDs along a same concentric circle 206 forms a same angle with the substrate 210 and the light emitting axis defines the axis of a cone formed by light emitted by the LEDs 202. A micro lens 230 is disposed opposite to each LED 202 for narrowing a light diverging angle of the light cone and/or for enhancing directionality of the emitting light. A light 204 is emitted by the LEDs 202 towards the light reflecting surface 222 along the light emitting axis 202a of the LEDs 202, wherein the light 204 impinges on the light reflecting surface 204 and reflects, and the reflected light passes through the opening 210a of the substrate 210 focusing towards the other side of the substrate 210.

In the foregoing light emitting module, according to an embodiment of the present invention, the angle formed between the light emitting axis 202a of the LEDs 202 is adjustable for converging light on the reflective device 220 in a manner reduce light energy loss of the light source module. Additionally, the adjustment of the light emitting axis 202a is substantially simple, providing a large angle allowance, thus providing higher flexibility in designing the optical engines. For example, the light emitting axes 202a of the LEDs 202 can be adjusted parallel to each other for providing a parallel light source, or extension of the light emitting axes 202a of the LEDs 202 can be converged at a point for providing a converging or diverging light source. The focal point of the light source module can be easily manipulated with the angle variation.

What is worth mentioning is, a curvature of the light reflecting surface 222 of the reflective device 220 facilitates the light path adjustment. In one embodiment of the present invention, the light reflective surface 222 can further be planar, yet the light source provided by the LEDs 202 has to be a focused light such that the light 204 is diverged on the other side of the substrate 210. Moreover, with the adjustment of the size of the circular hole 210a, the flux of light can be manipulated for controlling the brightness of the light source. Furthermore, the shape of the opening 210a of the substrate 210 can be polygonal, rectangular or triangular.

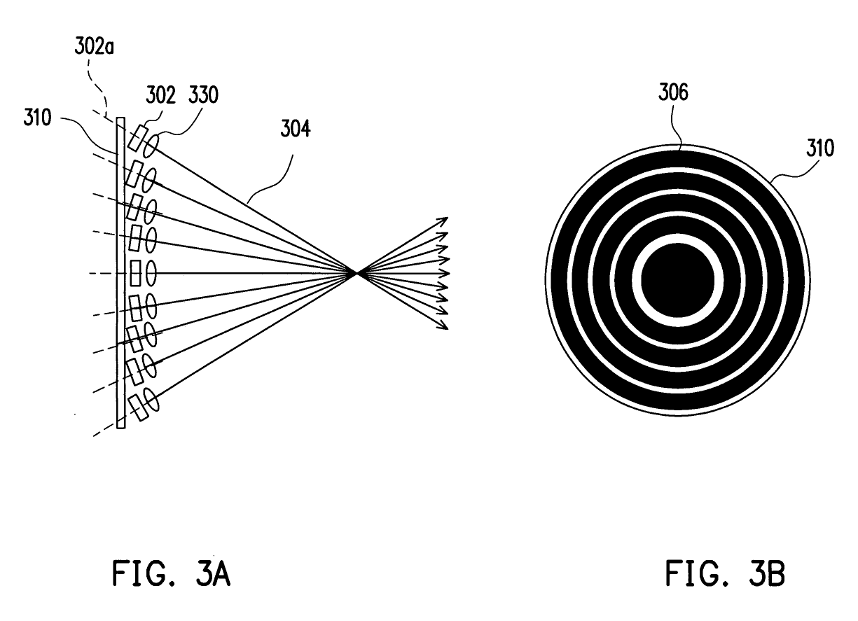

A light source module according to another embodiment of the present invention is described with reference to FIGS. 3A and 3B, wherein a side view diagram of the light source module is illustrated in FIG. 3A, and an arrangement of the LEDs is illustrated in FIG. 3B. A plurality of LEDs 302 is disposed on a substrate 310, wherein the LEDs 302 are arranged in a plurality of concentric circles 306, and a space between any two neighboring LEDs in any one of the concentric circles is substantially identical. Each of the LEDs 302 has a light emitting axis 302a, wherein the light emitting axes 302a of the LEDs 302 along a same concentric circle form a same angle with the substrate 310, and a light 304 is respectively emitted along the light emitting axis 302a of the LEDs. Moreover, a micro lens 330 is disposed in front of each of the LEDs 302 for enhancing the directionality of the emitted light from the LEDs 302. By adjusting light emitting angle of the LEDs of the light source module, light is converged.

In the foregoing two light source modules, according to an embodiment of the present invention, for providing uniform light, it is preferred that the angle between the light emitting axis of the LEDs and the substrate is substantially identical, and a space between any two neighboring LEDs is substantially identical. Alternatively, the space between any two neighboring LEDs, and the angle between the light emitting axis of the LEDs and the substrate, or a space between neighboring concentric circles can be more flexible according to the light emitting mode requirement.

Accordingly, light source module of the present invention has at least the following characteristics and advantages.

The LEDs are arranged in concentric circles for providing uniform light.

The light source module is constructed using simple optical lenses and therefore the volume and the weight of the light source module can be substantially reduced and also the cost thereof can be reduced.

Light converging effect is achieved with limited amount of optical lens module and thereby reducing loss of light energy, and therefore light efficiency is enhanced.

A focal point of the light source can be adjusted with manipulating the reflecting surface of the reflecting angle of the reflective device of the LEDs, thus design of optical engines is simplified and device installation and calibration is simplified.

The LEDs along a concentric circle can be viewed upon as a light source unit, thus the brightness of the light source can be adjusted by including a desired number of concentric circles of LEDs in a manner described above.

Although the invention has been described with reference to a particular embodiment thereof, it will be apparent to those skilled in the art that modifications to the described embodiment may be made without departing from the spirit of the invention. Accordingly, the scope of the invention will be defined by the attached claims and not by the above detailed description.

What is claimed is:

1. A light source module, comprising:
a substrate, having an opening;
a reflective device, disposed at one side of the substrate, wherein the reflective device comprises a light reflecting surface; and
a plurality of light emitting diodes (LEDs), disposed over the substrate between the reflective device and the substrate, wherein each of the light emitting diodes are arranged around the opening in a plurality of concentric circles, wherein each of the LEDs emits a light towards the light reflecting surface and the light is reflected by the light reflecting surface and passes through the opening, and wherein the reflected lights of each LEDs are converged at another side of the substrate.

2. The light source module as recited in claim 1, wherein the opening is a circular hole, and the circular hole and the concentric circles share a common center.

3. The light source module as recited in claim 1, wherein a space between any two neighboring LEDs in any one of the concentric circles is substantially identical.

4. The light source module as recited in claim 1, wherein each of the LEDs comprises a light emitting axis forming a same angle with the substrate, and the lights emitted by the LEDs travel along respective light emitting axes.

5. The light source module as recited in claim 1, wherein the light reflective surface comprises a flat surface or a curved surface.

6. The light source module as recited in claim 1, further comprising a plurality of micro lenses, wherein each of the micro lenses is correspondingly disposed opposite each LED.

7. A light source module, comprising:
a substrate; and
a plurality of light emitting diodes, disposed over one surface of the substrate, wherein the LEDs are arranged as a plurality of concentric circles, each of the LEDs emits a light along a light emitting axis thereof, and the light emitting axes converge at a same position.

8. The light source module as recited in claim 7, wherein a space between any two neighboring LEDs in any one of the concentric circles is substantially identical.

9. The light source module as recited in claim 7, wherein each of the LEDs comprises a light emitting axis forming a same angle with the substrate, and the lights emitted by the LEDs travel along respective light emitting axis.

10. The light source module as recited in claim 7, further comprising a plurality of micro lenses, wherein each of the micro lenses is correspondingly disposed opposite to each LED.
